(19) United States
(12) Patent Application Publication
(10) Pub. No.: US 2015/0076050 A1
(43) Pub. Date: Mar. 19, 2015

(54) Container system for dispensing filtered and unfiltered liquids

(71) Applicant: QuenchWorks, LLC, Dallas, TX (US)

(72) Inventor: Myron R. May, Dallas, TX (US)

(21) Appl. No.: 14/029,457

(22) Filed: Sep. 17, 2013

(51) Int. Cl. B01D 35/02

(52) U.S. Cl. CPC B01D 35/02
USPC 210/232

(57) ABSTRACT

A modular container system adapted for dispensing both filtered and unfiltered liquids. The system comprises a bottle having an upwardly-extending annular opening, and a cap adapted to mate with the upwardly-extending annular opening to form a sealed container. The bottle is one of a set of bottles having differing volumes and profiles; each bottle has the same upwardly-extended annular opening. The system may include a filter mechanism that adapted to be removable from an internal receiving cylinder of the cap when the bottle is used to dispense unfiltered liquids. When secured to the receiving cylinder of the cap, a filter body of the filter mechanism is contained within a profile of the cap in such a way as to allow universal use of the cap and filter construct on multiple-sized and profiled bottles that include the same upwardly-extended annular openings.

### BACKGROUND

1. Technical Field

The subject matter herein relates generally to drinking containers.

2. Background of the Related Art

“Sippy” cups are well-known in the prior art. These are spill-proof drinking cups designed for toddlers. A sippy cup works by way of surface tension that prevents the liquid in the cup from being spilled even when the cup is turned upside down. The cup typically comprises a body and a sippy top that is retained securely to the body. The cup may also include an integral handle for easy grasping and retaining by the child.

A water bottle is a container, typically formed of plastic, to hold water or other beverages for consumption. It is designed for easy transport by an individual, and it may be disposable or reusable. Some water bottles include filtration systems or filter mechanisms to improve water quality, or to provide acceptable quality for the source liquid that may include water-borne contaminants or pathogens. Such filters may be supported in a removable straw-type arrangement for ease of cleaning and replacement. Typically, a filter of this type uses carbon material, such as activated charcoal, as the active filtering material. Representative bottles of this type are available commercially under the brands Camelbak® and Brita®, among others.

While filtration bottles of this type are useful, the filter system/mechanism typically extends throughout the length of the bottle housing. As a result, these types of container systems have to be used in large-size bottles, and they are not flexible enough to be adapted for use for containers that may have different use requirements or wherein it is desired to provide a container to dispense both filtered and unfiltered liquids using a same cap structure.

### BRIEF SUMMARY

A container system is described for use in dispensing both filtered and unfiltered liquids. The system comprises a bottle having an upwardly-extending annular opening, and a cap adapted to mate with the upwardly-extending annular opening to form a sealed container. Preferably, the bottle is one of a set of bottles having differing volumes and profiles; each bottle has the same upwardly-extended annular opening. The system may include a filter mechanism that is adapted to be removed from an internal receiving cylinder of the cap when the bottle is used to dispense unfiltered liquids. When secured to the receiving cylinder of the cap, a filter body of the filter mechanism is contained within a profile of the cap in such a way as to allow universal use of the cap and filter construct on multiple-sized and profiled bottles that include the same upwardly-extended annular openings.

In a particular embodiment, the container system comprises a particular bottle (selected from the set of bottles) having the upwardly-extending annular opening, and the cap adapted to mate with the upwardly-extending annular opening to form the sealed container. The cap is generally conical and, in one embodiment, it has a swoped outer exterior surface. The cap also includes an outlet adjacent an upper portion of the outer surface and through which a liquid is dispensed. The cap further includes a downwardly-extending internal receiving cylinder having a support structure (e.g., a flange or threading) at its lower end. An inner wall of the cap outer surface, together with an inner opposed wall of the cap, form a chamber in an upper portion of the cap. The inner opposed wall of the cap preferably has a semi-circular notch extending into the chamber. The container system also includes a gasket snugly received and fitted in the chamber and secured therein by the notch. The gasket has a central cavity with an opening at a bottom thereof, and a non-drip valve at an upper portion thereof adjacent the outlet in the cap. The non-drip valve is adapted to permit the liquid to be dispensed through the valve and the outlet upon a suction force being applied during drinking. As noted above, the container system may include an optional filter mechanism. A filter mechanism may comprise a body having an upwardly-extending annular opening, and a end cap structure that supports a filter material therein. The body of the filter mechanism may include a retaining flange (or threading) extending laterally along an outer upper surface thereof. An upper portion of the body of the filter mechanism is adapted to be securely received and fixed in the internal receiving cylinder of the cap by the upwardly-extending annular opening of the body being received in the central cavity of the gasket and the retaining flange being received and secured against the flange of the receiving cylinder. The filter mechanism is adapted to be removed from the cap's internal receiving cylinder when the bottle is used to dispense unfiltered liquids.

In this manner, the container system is useful to dispense both filtered and unfiltered liquids. When it is desired to dispense just unfiltered liquids (e.g., juice), an individual simply separates the cap from the bottle, removes the filter mechanism, re-assembles the cap to the bottle, and drinks from the sealed container in a usual manner. The filter mechanism may be easily positioned back in the cap when it is desired to use the container system to dispense filtered liquids (e.g., water).

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject disclosure and the advantages thereof, reference is now made to the following descriptions taken in conjunction with the accompanying drawings, in which:

FIG. 1 is an elevation view of the container system illustrating a set of three (3) different containers that use (share) a single cap assembly structure, shown in cut-a-way;

FIG. 2 is an isometric view of a first model of the container system of FIG. 1, especially adapted for use as a sippy cup;

FIG. 3 is an exploded view of the first model showing the basic structural components;

FIG. 4 is a front view of the first model;

FIG. 5 is a side sectional view of the first model of the container system taken along line 5-5′ in FIG. 4 illustrating the structural details and arrangements of the various parts; and

FIG. 6 is a bottom sectional view of the first model taken along line 6-6′ in FIG. 4 and looking up into the internal structures.

### DETAILED DESCRIPTION

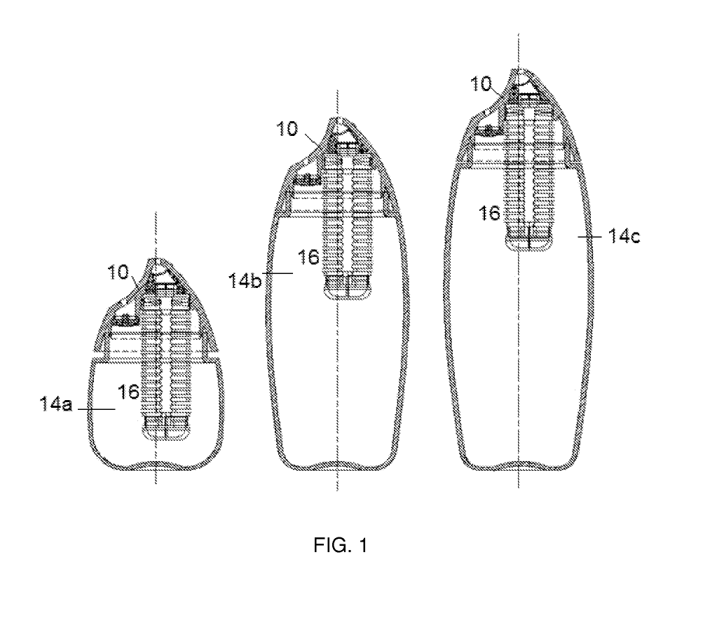

FIG. 1 illustrates is an elevation view of the container system of this disclosure illustrating a set of three (3) different containers that use (share) a single cap assembly structure, shown in cut-a-way. While three different containers are shown, this is not a limitation, as the system may comprise any number (e.g., 2 or more) bottles. As illustrated, the single cap assembly 10 is adapted to be used with any of the different bottles 14a, 14b and 14c in this example system, to form various models of the container system. Preferably, the system is available as a “kit” comprising a single cap assembly, a set of removable filters 16, and the set of bottles. When it is desired to form a “sippy” cup, for example, a user attaches the cap 10 to the first bottle 14a; that cup can then be used to dispense filtered liquid (e.g., water) when the filter 16 is included (as shown), or the cup can be used to dispense non-filtered liquids (e.g., juice) when the filter 16 is omitted. In this same manner, the single cap assembly may be attached to any one of the bottles to form a sealed container with a distinct volume and profile.

As can be seen in FIG. 1, each of the sealed container models has a distinct volume and profile. The filter is adapted to be removed from the cap when the bottle is used to dispense unfiltered liquids. A particular advantage of this system is that, when secured in the cap in a manner to be described in more detail below, a filter body of the filter is contained within a profile of the cap in such a way as to allow universal use of the cap and filter construct on the multiple-sized and profiled bottles that include the same upwardly-extended annular openings. This system provides significant advantages over the hard-walled filtration bottles of the prior art, which do not provide flexibility for multi-use scenarios.

Without meant to be limiting, the bottle and cap are formed of a plastic material, such as BPA-free polypropylene, polyethylene or polyethylene terephthalate, bioplastics (e.g., PLA), and the like. Without meant to be limiting, the various models come in the following volumes such as 8, 16 and 22 ounces.

Without meant to be limiting, the various models may be formed of different colored material such that the system provides a variety or set of colored sealed containers when in use.

The outer portions of the bottles may include other indicia or graphics.

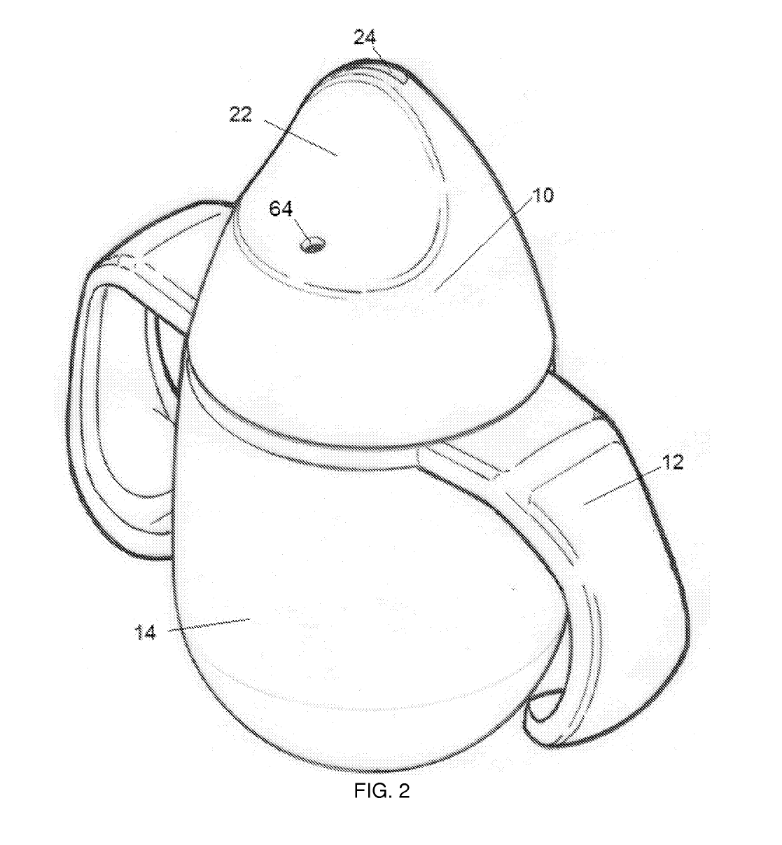

FIG. 2 is an isometric view of a first model of the container system of FIG. 1, especially adapted for use as a sippy cup. The basic elements of this model comprise the cap assembly 10, an arm ring 12 having a pair of arms for easy grasping, and the bottle 14. When used as a sippy cup, the cap assembly 10 advantageously is generally conical and includes an outer exterior surface 22 that terminates in an outlet 24 adjacent an upper portion of the outer surface 22 and through which liquid is dispensed. As noted above, in one embodiment the outer exterior surface may have a swoped contour, but this is not a limitation. The cap assembly may also include an air return hole/vent 64, as will be described in more detail below. The arm ring 12 is optional and may be omitted, particularly when the cap assembly is used for the larger volume models.

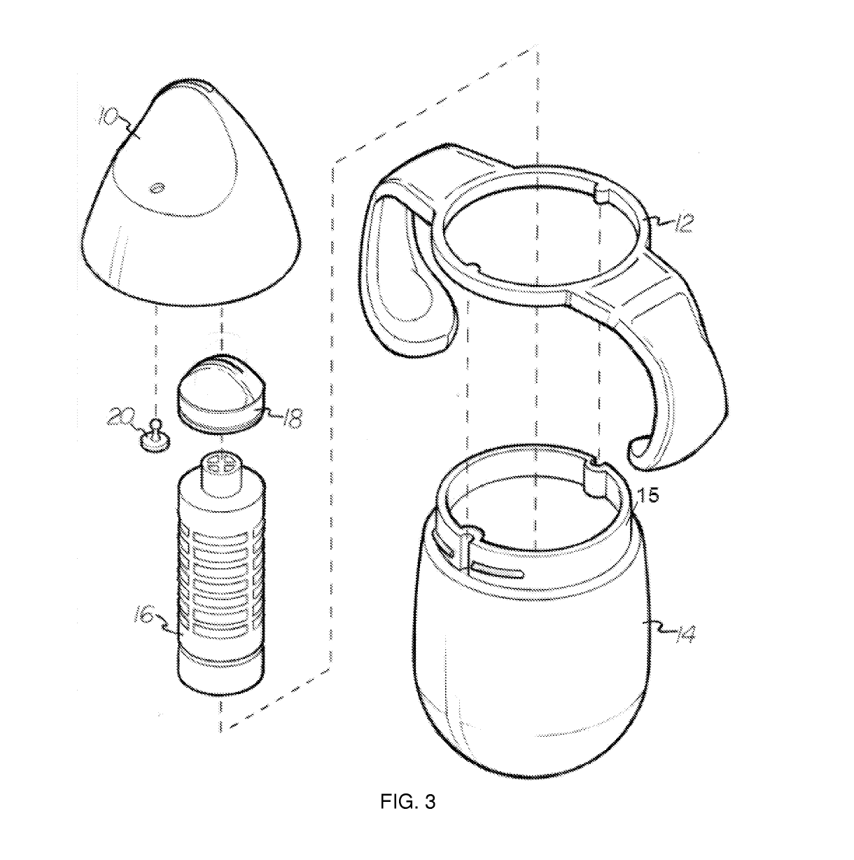

FIG. 3 is an exploded view of the first model showing the basic structure as well as several additional components. In particular, this view shows that bottle 14 has an upwardly-extending annular opening 15. The cap assembly is designed to mate with the upwardly-extending annular opening 15 to form a sealed container, such as the sippy cup in FIG. 2. As will be described in more detail below, preferably the container system includes a non-drip valve 18, and a one-way air return valve 20. The non-drip valve 18 is adapted to permit liquid to be dispensed through the valve 18 and the outlet 24 upon a suction force being applied, e.g., such as when the bottle is held inverted (upside-down) and suction force is applied to outlet 24. Otherwise, the non-drip valve 18 provides a leak-proof arrangement to retain the liquid in the sealed container. The one-way valve 20 acts as an air-return path when the suction force is being applied during drinking.

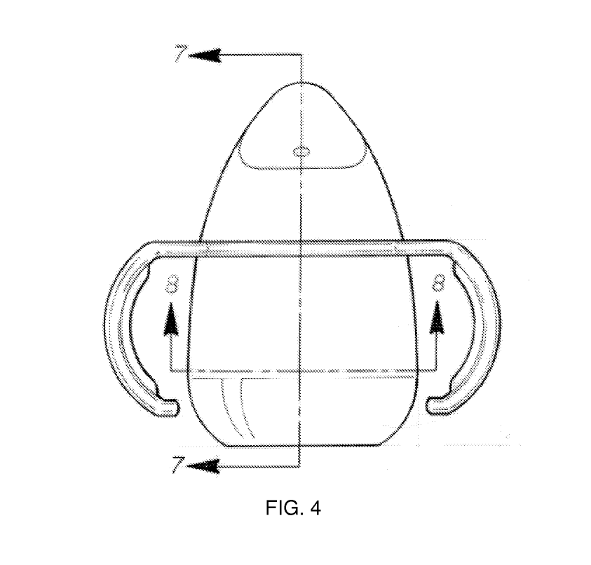

FIG. 4 is a front view of the first model, looking towards the cap outer exterior surface.

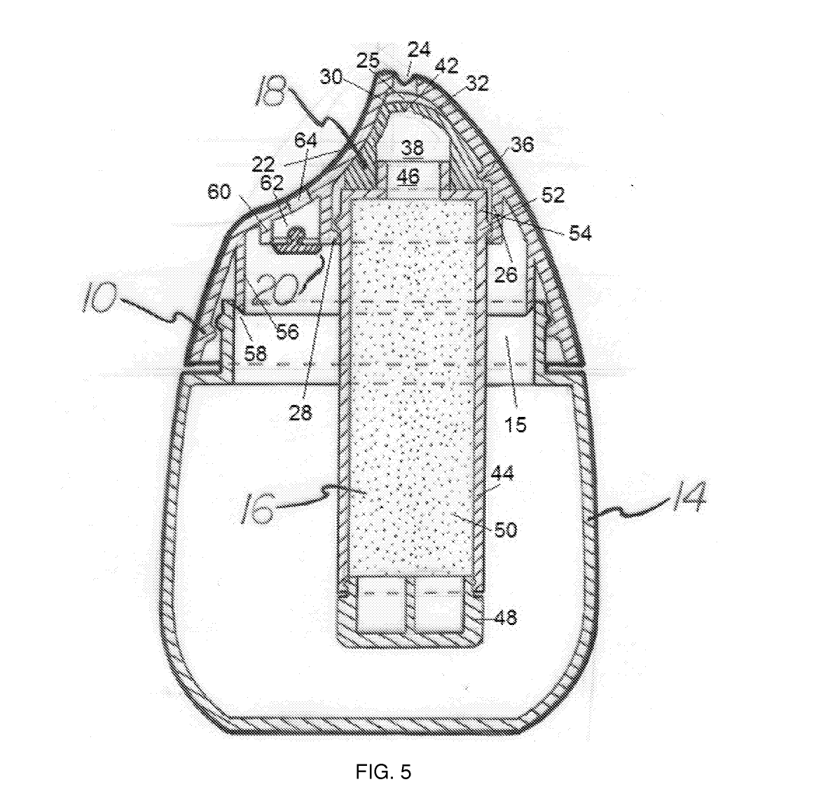

FIG. 5 is a side sectional view of the first model of the container system taken along line 5-5′ in FIG. 4 and illustrating the structural details and arrangements of the various parts in additional detail. In this particular embodiment, the container system comprises a particular bottle (selected from the set of bottles in FIG. 1) having the upwardly-extending annular opening 15, and the cap 10 adapted to mate with the upwardly-extending annular opening to form the sealed container. In this embodiment, the sealed container is a sippy-type cup, although this is not a limitation. The arm ring (element 12 in FIG. 2) is omitted for convenience of illustration. As noted, preferably the cap 10 is generally conical and has the outer exterior surface 22. The outer exterior surface 22 may be swoped, conical, flat, or any other shape that is convenient for drinking. The cap also includes the outlet 24 adjacent an upper portion of the outer surface 22 and through which the liquid is dispensed. The cap 10 further includes a downwardly-extending internal receiving cylinder 26 having a flange 28 (or threading) at its lower end. An inner wall 30 of the outer surface together with an inner opposed wall 32 of the cap 10 and the receiving cylinder 26 form a chamber 25 in an upper portion of the cap. The inner opposed wall 32 of the cap 10 preferably has a semi-circular notch profile 36 to secure the non-drip valve 18 into the chamber 25.

The container system also includes the non-drip valve (or gasket) 18 snugly received and fitted in the chamber 25 and secured therein by the notch 36. The gasket 18 has a central cavity 38 with an opening at a bottom thereof, and a non-drip valve 42 at an upper portion thereof adjacent the outlet in the cap. The non-drip valve 42 is adapted to permit the liquid to be dispensed through the valve 18 and the outlet 24 upon a suction force being applied. This gasket preferably is formed of a flexible material such as silicone.

As noted above, the container system may include an optional filter mechanism 16. A filter mechanism may comprise a body or housing 44 having an upwardly-extending annular opening 46, and an end cap structure 48 that closes the filter bottom end and supports a filter material 50 therein. The body of the filter mechanism may include a retaining flange (or threading) 52 extending laterally about an outer upper surface thereof. An upper portion 54 of the body of the filter mechanism is adapted to be securely received and fixed into the internal receiving cylinder 26 of the cap by the upwardly-extending annular opening 46 of the body 44 being received in the central cavity 38 of the gasket 18 and the retaining flange (threading) 52 being received and secured against the flange (threading) 28 of the receiving cylinder 26 of the cap 10. As described, the filter mechanism 16 is adapted to be removed from the cap internal receiving cylinder 26 when the bottle 14 is used to dispense unfiltered liquids.

The filter material preferably is porous or packed in such a manner to allow liquids to pass through the filter while trapping impurities. The liquid enters the filter housing through vents or openings molded in the side wall.

In this manner, the container system is useful to dispense both filtered and unfiltered liquids. When it is desired to dispense just unfiltered liquids (e.g., juice), an individual simply separates the cap from the bottle, then removes the filter mechanism, re-assembles the cap to the bottle, and drinks from the drip-proof sealed container by applying suction force to the opening 24. The filter mechanism may be easily positioned back in the cap when it is desired to use the container system to dispense filtered liquids (e.g., water).

As also seen in FIG. 5, the cap assembly 10 further includes a downwardly-extending internal structure 56 having a chamfered bottom edge 58 adapted to form a liquid-tight seal with respect to the upwardly-extending annular opening 15 in the bottle 14 when the cap 10 is secured to the bottle to form the sealed container.

As also seen in FIG. 5, the cap preferably also includes another downwardly-extending internal structure in the form of a cylinder 60 having an opening therein, the downwardly-extending structure 60 defining a second chamber 62 underlying a portion of the outer surface 22. The outer surface 22 includes the hole/vent 64 opening into the second chamber 62. The second chamber supports the one-way valve 20 to act as the air-return path when the suction force is being applied to opening 24, as previously described.

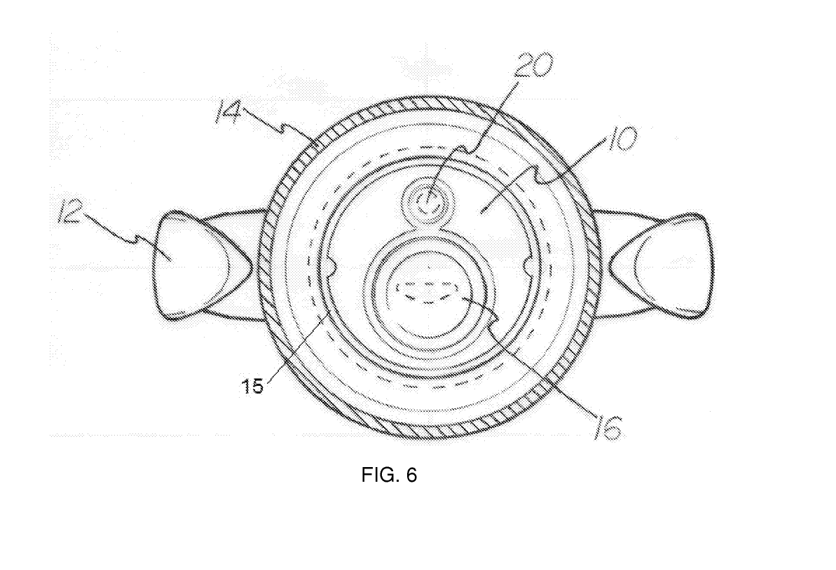

FIG. 6 illustrates a bottom sectional view of the structures shown in FIG. 4 to provide additional details regarding the receiving cylinders within the cap assembly.

The filter material may be of varying types. A representative filter material 50 is an activated charcoal suspended in a non-woven mesh. In a variant, the filter material 50 is an activated charcoal suspended in an anti-bacterial, anti-fungal mesh. Other types of filter material(s) may be used.

The filter mechanism is designed to be modular and replaceable.

Having described my invention, what I now claim is as follows.

1. A container system for dispensing filtered and unfiltered liquids, comprising:
a bottle having an upwardly-extending annular opening;
a cap adapted to mate with the upwardly-extending annular opening to form a sealed container, the cap being generally conical and having an outer exterior surface, the cap further including an outlet adjacent an upper portion of the outer surface and through which a liquid is dispensed, the cap further including a downwardly-extending internal receiving cylinder having a support structure at its lower end, wherein an inner wall of the outer surface together with an inner opposed wall of the cap and the receiving cylinder form a chamber in an upper portion of the cap, the inner opposed wall of the cap having a semi-circular notch extending into the chamber;
a gasket snugly received and fitted in the chamber and secured therein by the notch, the gasket having a central cavity with an opening at a bottom thereof, and a non-drip valve at an upper portion thereof adjacent the outlet in the cap, the non-drip valve adapted to permit the liquid to be dispensed through the non-drip valve and the outlet upon a suction force being applied; and
a filter mechanism comprising a body having an upwardly-extending annular opening, and a filter material therein, the body having a retaining structure extending laterally about an outer upper surface thereof, the body having an upper portion adapted to be securely received and fixed in the internal receiving cylinder of the cap by the upwardly-extending annular opening of the body being received in the central cavity of the gasket and the retaining structure being received and secured against the support structure of the receiving cylinder;
the filter mechanism adapted to be removably-detachable from the cap internal receiving cylinder when the bottle is used to dispense unfiltered liquids.

2. The container system as described in claim 1 wherein the cap further includes a downwardly-extending internal structure having a chamfered bottom edge adapted to form a liquid-tight seal with respect to the upwardly-extending annular opening in the bottle when the cap is secured to the bottle to form the sealed container.

3. The container system as described in claim 1 wherein the cap further includes a downwardly-extending internal structure having an opening therein, the downwardly-extending structure defining a second chamber underlying a portion of the outer surface.

4. The container system as described in claim 3 wherein the outer surface includes a hole opening into the second chamber, the second chamber supporting a one-way valve to act as an air-return path when the suction force is being applied to the outlet during drinking.

5. The container system as described in claim 1 wherein the bottle is one of a set of bottles having differing volumes and profiles.

6. The container system as described in claim 5 wherein the filter body, when secured to the receiving cylinder of the cap, is contained substantially within a profile of the cap, such that the cap and filter are useable within each of the set of bottles having differing volumes and profiles.

7. The container system as described in claim 1 wherein the filter material is an activated charcoal suspended in a non-woven mesh.

8. The container system as described in claim 1 wherein the filter material is suspended in an anti-bacterial, anti-fungal mesh.

9. The container system as described in claim 1 wherein the outer surface has a swoped contour.
